(19) United States
(12) Patent Application Publication
(10) Pub. No.: US 2024/0379967 A1
(43) Pub. Date: Nov. 14, 2024

(54) COMPOSITION FOR FORMING THIN FILM FOR ENERGY STORAGE DEVICE ELECTRODE

(71) Applicant: Nissan Chemical Corporation, Tokyo (JP)

(72) Inventors: Takuma NAGAHAMA, Funabashi-shi (JP); Shun FUJITA, Funabashi-shi (JP)

(73) Assignee: Nissan Chemical Corporation, Tokyo (JP)

(21) Appl. No.: 18/287,409

(22) PCT Filed: Mar. 28, 2022
(86) PCT No.: PCT/JP2022/014793

§ 371 Date: Oct. 18, 2023

(30) Foreign Application Priority Data
Apr. 27, 2021 (JP) 2021-075208

(51) Int. Cl. H01M 4/66; H01M 10/0525

(52) U.S. Cl. CPC H01M 4/667; H01M 10/0525

(57) ABSTRACT

Provided is a composition, which is for forming a thin film for an energy storage device electrode and contains a conductive carbon material, a heterocyclic compound containing at least two nitrogen atoms constituting a ring, a dispersant, and a solvent, as a composition which is for forming a thin film for an energy storage device electrode and can be suitably used for forming a conductive thin film, and from which an undercoat layer exhibiting the effect of suppressing migration can be provided, in particular, in an energy storage device.

### TECHNICAL FIELD

The present invention relates to a thin film forming composition for energy storage device electrodes.

### BACKGROUND ART

In recent years, with the demand for miniaturization, weight reduction, and high functionality of portable electronic devices such as smartphones, digital cameras, and portable game machines, development of high-performance batteries has been actively promoted, and the demand for secondary batteries that can be repeatedly used by charging has been greatly increased. Among secondary batteries, lithium ion secondary batteries are currently most actively developed because they have high energy density and high voltage, and are free of a memory effect at the time of charge and discharge. In recent years, development of electric vehicles also has been actively promoted in response to environmental problems, and secondary batteries as a power source thereof have been required to have further high performance.

A lithium ion secondary battery has a structure in which a positive electrode and a negative electrode that are capable of intercalating and deintercalating lithium, and a separator interposed therebetween are housed in a container, and an electrolyte solution (in the case of a lithium ion polymer secondary battery, a gel-like electrolyte instead of a liquid electrolyte solution) fills the container.

The positive electrode and the negative electrode are generally manufactured by applying a composition including an active material capable of intercalating and deintercalating lithium, a conductive material mainly including a carbon material, and a polymer binder to a current collector such as a copper foil or an aluminum foil. The binder is used for bonding the active material, the conductive material, and the metal foil to each other, and examples of the commercially available binder include fluorine-based resins soluble in N-methylpyrrolidone (NMP), such as polyvinylidene fluoride (PVdF), and aqueous dispersions of an olefin-based polymer.

However, the adhesiveness of the binder to the current collector is not sufficient, so that during a manufacturing process such as an electrode cutting process or winding process, a part of the active material or the conductive material is stripped off and separated from the current collector, and as a result, a minute short circuit or variation in battery capacity may be caused. Furthermore, a long-term use causes swelling of the binder by the electrolyte solution and causes volume change of the electrode mixture accompanying the volume change of the active material due to lithium intercalation and deintercalation, resulting in a problem of battery capacity deterioration caused by an increase in the contact resistance between the electrode mixture and the current collector or by stripping and separation of a part of the active material or the conductive material from the current collector, and resulting in a problem of the safety.

As an attempt to solve the above problems, a method in which a conductive undercoat layer is interposed between a current collector and an electrode mixture layer has been developed as a technique of reducing the resistance of a battery by increasing the adhesion between the current collector and the electrode mixture layer to reduce the contact resistance. For example, Patent Document 1 discloses a technique in which a conductive layer including carbon as a conductive filler is disposed as an undercoat layer between a current collector and an electrode mixture layer. Patent Document 1 shows that by using the composite current collector including the undercoat layer, the contact resistance between the current collector and the electrode mixture layer can be reduced, a decrease in the capacity at the time of fast discharge can be suppressed, and deterioration of the battery can also be suppressed. Patent Documents 2 and 3 also disclose a similar technique. Patent Documents 4 and 5 disclose an undercoat layer including a carbon nanotube (hereinafter, also abbreviated as CNT) as a conductive filler.

However, in an energy storage device, ion migration (hereinafter, simply referred to as “migration”) of the metal included in the current collector may occur to cause early deterioration of the device. Therefore, suppression of migration is awaited from the viewpoint of improving the stability of the energy storage device.

### PRIOR ART DOCUMENTS

### Patent Documents

Patent Document 1: JP-A H9-097625
Patent Document 2: JP-A 2000-011991
Patent Document 3: JP-A H11-149916
Patent Document 4: WO 2014/042080
Patent Document 5: WO 2015/029949

### SUMMARY OF INVENTION

### Technical Problem

The present invention has been made in view of such circumstances, and an object of the present invention is to provide a thin film forming composition for energy storage device electrodes, that can be suitably used for forming a conductive thin film, and particularly, can provide an undercoat layer capable of exhibiting an effect of suppressing migration in an energy storage device.

### Solution to Problem

As a result of intensive studies to achieve the above object, the present inventors have found that a thin film obtained from a composition including a conductive carbon material, a heterocyclic compound including two or more nitrogen atoms constituting a ring, a dispersant, and a solvent is capable of suppressing migration from a current-collecting substrate, and thus the present invention has been completed.

That is, the present invention provides a thin film forming composition for energy storage device electrodes as described below.

1. A thin film forming composition for energy storage device electrodes, including a conductive carbon material, a heterocyclic compound including two or more nitrogen atoms constituting a ring, a dispersant, and a solvent.
2 The thin film forming composition for energy storage device electrodes of 1 above, wherein the heterocyclic compound has the following formula (n1):

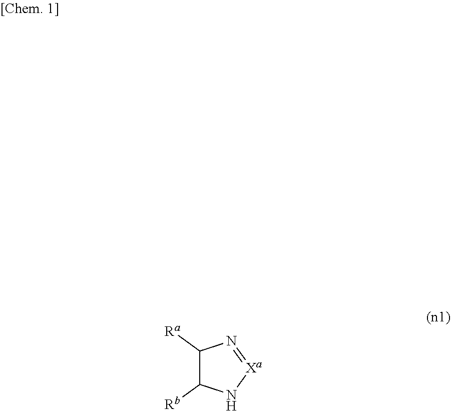

wherein R^{a} and R^{b} each independently represent a hydrogen atom, a halogen atom, an alkyl group that has 1 to 6 carbon atoms and may have a substituent, an alkenyl group that has 2 to 6 carbon atoms and may have a substituent, or an aryl group that has 6 to 12 carbon atoms and may have a substituent, R^{a} and R^{b} may be bonded to each other to form a ring having 4 to 6 carbon atoms, and X^{a} is N or CH.
3. The thin film forming composition for energy storage device electrodes of 2 above, wherein each substituent is at least one selected from the group consisting of a carboxy group, a hydroxy group, a thiol group, an amino group, a sulfonate group, and an epoxy group.
4. The thin film forming composition for energy storage device electrodes of 2 or 3 above, wherein the heterocyclic compound has the following formula (n2):

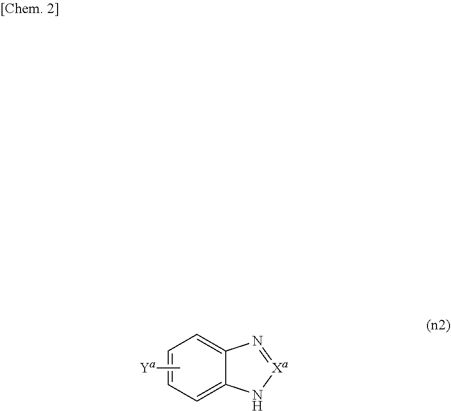

wherein Y^{a} represents a hydrogen atom, a carboxy group, a hydroxy group, a thiol group, an amino group, a sulfonate group, or an epoxy group, and X^{a} is as described above.
5. The thin film forming composition for energy storage device electrodes of 4 above, wherein the heterocyclic compound has the following formula (n3):

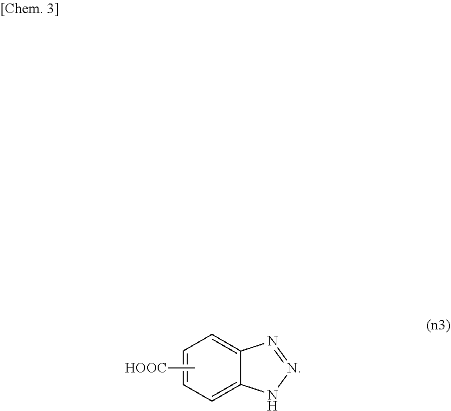

6. The thin film forming composition for energy storage device electrodes of any one of 1 to 5 above, wherein the dispersant includes a pendant oxazoline group-containing polymer.
7. The thin film forming composition for energy storage device electrodes of any one of 1 to 6 above, wherein the solvent includes one or more selected from the group consisting of water and hydrophilic solvents.
8. The thin film forming composition for energy storage device electrodes of any one of 1 to 7 above, further including a crosslinking agent.
9. An undercoat layer including a thin film obtained from the thin film forming composition for energy storage device electrodes of any one of 1 to 8 above.
10. A composite current collector for energy storage device electrodes, including a current-collecting substrate and the undercoat layer of 9 above formed on the current-collecting substrate.
11. The composite current collector for energy storage device electrodes of 10 above, wherein the current-collecting substrate is a copper foil.
12. An electrode for energy storage devices, including the composite current collector for energy storage device electrodes of 10 or 11 above.
13. An energy storage device including the electrode for energy storage devices of 12 above.
14. The energy storage device of 13 above, being a lithium ion battery.
15. The energy storage device of 13 above, wherein an electrolyte is a solid.
16. The energy storage device of 13 above, being an all-solid-state battery.

### Advantageous Effects of Invention

The thin film forming composition for energy storage device electrodes of the present invention is suitable as a composition for formation of an undercoat layer that bonds a current collector constituting an energy storage device electrode and an electrode mixture layer together, and using the composition for formation of an undercoat layer on the current collector enables suppression of migration from a current-collecting substrate.

### DESCRIPTION OF EMBODIMENTS

The thin film forming composition for energy storage device electrodes according to the present invention (hereinafter, sometimes simply referred to as “composition”) includes a conductive carbon material, a heterocyclic compound including two or more nitrogen atoms constituting a ring (hereinafter, sometimes simply referred to as “nitrogen-containing heterocyclic compound”), a dispersant, and a solvent.

The conductive carbon material is not particularly limited, and can be appropriately selected for use from known conductive carbon materials such as carbon black, Ketjen black, acetylene black, carbon whiskers, carbon nanotubes (CNTs), carbon fibers, natural graphite, and synthetic graphite, and CNTs are particularly preferable from the viewpoints of conductivity, dispersibility, availability, and the like.

CNTs are generally produced with an arc discharge method, a chemical vapor deposition method (CVD method), a laser ablation method, or the like, and the CNT used in the present invention may be obtained by any of these methods. CNTs are categorized as single-walled CNTs consisting of a single cylindrically rolled carbon film (graphene sheet) (abbreviated below as SWCNTs), double-walled CNTs consisting of two concentrically rolled graphene sheets (abbreviated below as DWCNTs), and multi-walled CNTs consisting of a plurality of concentrically rolled graphene sheets (MWCNTs). In the present invention, SWCNTs, DWCNTs, or MWCNTs may be used alone, or a plurality of these types of CNTs may be used in combination.

When the above methods are used to produce SWCNTs, DWCNTs, or MWCNTs, a catalyst metal such as nickel, iron, cobalt, or yttrium may remain in the product, and therefore purification to remove the impurity is sometimes necessary. For the removal of the impurity, acid treatment with nitric acid, sulfuric acid, or the like and ultrasonic treatment are effective. However, in the acid treatment with nitric acid, sulfuric acid, or the like, the π-conjugated system making up the CNTs may be destroyed to impair the properties inherent to the CNTs, so that it is desirable to purify and use the CNTs under suitable conditions.

Specific examples of the CNTs that may be used in the present invention include CNTs synthesized with the super growth method (manufactured by the New Energy and Industrial Technology Development Organization in the National Research and Development Agency), eDIPS-CNTs (manufactured by the New Energy and Industrial Technology Development Organization in the National Research and Development Agency), the SWNT series (manufactured by MEIJO NANO CARBON Co., Ltd.: trade name), the VGCF series (manufactured by Showa Denko K.K.: trade name), the FloTube series (manufactured by CNano Technology: trade name), AMC (manufactured by Ube Industries, Ltd.: trade name), the NANOCYL NC7000 series (manufactured by Nanocyl S.A.: trade name), Baytubes (manufactured by Bayer: trade name), GRAPHISTRENGTH (manufactured by Arkema S.A.: trade name), MWNT7 (manufactured by Hodogaya Chemical Co., Ltd.: trade name), Hyperion CNT (manufactured by Hypeprion Catalysis International: trade name), the TC series (manufactured by TODA KOGYO CORP.: trade name), the FloTube series (manufactured by Jiangsu Cnano Technology Ltd.: trade name), and LUCAN BT1003M (manufactured by LG Chem. Ltd.: trade name).

The nitrogen-containing heterocyclic compound is not particularly limited as long as it includes two or more nitrogen atoms constituting the ring, and can be appropriately selected from conventionally known compounds and used. However, in the present invention, imidazole derivatives, pyrazole derivatives, and triazole derivatives are preferable, imidazole derivatives and triazole derivatives are more preferable, and triazole derivatives are still more preferable. Specific usable examples are listed below.

Specific examples of the imidazole derivatives include imidazole, benzimidazole, 5-carboxybenzimidazole, and 4-carboxy benzimidazole.

Specific examples of the pyrazole derivatives include pyrazole, 1,2-benzopyrazole, 4-pyrazolecarboxylic acid, 3-pyrazolecarboxylic acid, and adenine.

The triazole derivatives are preferably benzotriazole-based compounds, and specific examples thereof include benzotriazole, carboxy benzotriazole, 5-carboxybenzotriazole, 4-carboxy benzotriazole, 5-hydroxy benzotriazole, 5-aminobenzotriazole, benzotriazole-4-sulfonic acid, 4-methylbenzotriazole, 5-methyl-1H-benzotriazole, 1-carboxy benzotriazole, 1-hydroxybenzotriazole, 1-aminobenzotriazole, 4-methylbenzotriazole, 5-methyl-1H-benzotriazole, benzotriazole-1-methylamine, 4-methylbenzotriazole-1-methylamine, 5-methylbenzotriazole-1-methylamine, N-methylbenzotriazole-1-methylamine, N-ethylbenzotriazole-1-methylamine, N,N-dimethylbenzotriazole-1-methylamine, N,N-diethylbenzotriazole-1-methylamine, N,N-dipropylbenzotriazole-1-methylamine, N,N-dibutylbenzotriazole-1-methylamine, N,N-dihexylbenzotriazole-1-methylamine, N,N-dioctylbenzotriazole-1-methylamine, N,N-bis(2-ethylhexyl)-benzotriazole-1-methylamine, N,N-dimethyl-4-benzotriazole-1-methylamine, N,N-dimethyl-5-benzotriazole-1-methylamine, N,N-diethyl-4-benzotriazole-1-methylamine, N,N-diethyl-5-benzotriazole-1-methylamine, N,N-dipropyl-4-benzotriazole-1-methylamine, N,N-dipropyl-5-benzotriazole-1-methylamine, N,N-dibutyl-4-benzotriazole-1-methylamine, N,N-dibutyl-5-benzotriazole-1-methylamine, N,N-dihexyl-4-benzotriazole-1-methylamine, N,N-dihexyl-5-benzotriazole-1-methylamine, N,N-bis(2-ethylhexyl)-4-methylbenzotriazole-1-methylamine, N,N-bis(2-ethylhexyl)-5-methylbenzotriazole-1-methylamine, N,N-dioleyl-4-methylbenzotriazole-1-methylamine, N,N-dioleyl-5-methylbenzotriazole-1-methylamine, N,N-distearyl-4-methylbenzotriazole-1-methylamine, N,N-distearyl-5-methylbenzotriazole-1-methylamine, 1-hydroxymethylbenzotriazole, 1-(2-ethylhexylamino)methyl)benzotriazole, and 1-(2,3-dihydroxypropyl)benzotriazole.

In the present invention, a compound having the following formula (n1) is particularly preferably used.

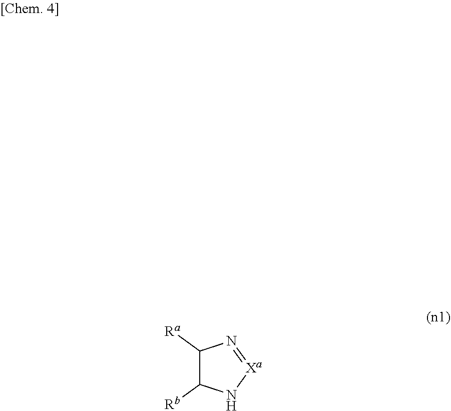

R^{a} and R^{b} above each independently represent a hydrogen atom, a halogen atom, an alkyl group that has 1 to 6 carbon atoms and may have a substituent, an alkenyl group that has 2 to 6 carbon atoms and may have a substituent, or an aryl group that has 6 to 12 carbon atoms and may have a substituent, R^{a} and R^{b} may be bonded to each other to form a ring having 4 to 6 carbon atoms, and X^{a} is N or CH.

Examples of the halogen atom include a fluorine atom, a chlorine atom, a bromine atom, and an iodine atom.

The alkyl group having 1 to 6 carbon atoms may be linear, branched, or cyclic, and specific examples of the alkyl group include linear or branched alkyl groups having 1 to 6 carbon atoms, such as a methyl group, an ethyl group, an n-propyl group, an isopropyl group, an n-butyl group, an isobutyl group, an s-butyl group, a t-butyl group, an n-pentyl group, and an n-hexyl group, and cyclic alkyl groups having 3 to 6 carbon atoms, such as a cyclopropyl group, a cyclobutyl group, a cyclopentyl group, and a cyclohexyl group.

Examples of the alkenyl group having 2 to 6 carbon atoms include ethenyl, n-1-propenyl, n-2-propenyl, 1-methylethenyl, n-1-butenyl, n-2-butenyl, n-3-butenyl, 2-methyl-1-propenyl, 2-methyl-2-propenyl, 1-ethylethenyl, 1-methyl-1-propenyl, 1-methyl-2-propenyl, and n-1-pentenyl groups.

Examples of the aryl group having 6 to 12 carbon atoms include phenyl, tolyl, 1-naphthyl, and 2-naphthyl groups.

Examples of the substituent include a carboxy group, a hydroxy group, a thiol group, an amino group, a sulfonate group, and an epoxy group.

Examples of the ring having 4 to 6 carbon atoms formed by bonding of R^{a} and R^{b} to each other include a cyclopentane ring, a cyclohexane ring, and a benzene ring.

X^{a} above is preferably N.

X^{a} is particularly more preferably a compound having the following formula (n2) in which R^{a} and R^{b} are bonded to each other to form a benzene ring.

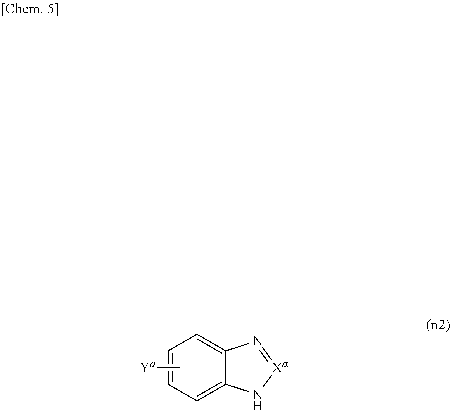

Y^{a} above represents a hydrogen atom, a carboxy group, a hydroxy group, a thiol group, an amino group, a sulfonate group, or an epoxy group. From the viewpoint of ensuring a migration suppression effect and improving adhesion between a current collector and an undercoat layer, Y^{a} is preferably a carboxy group, a hydroxy group, a thiol group, an amino group, a sulfonate group, or an epoxy group, and more preferably a carboxy group.

X^{a} above is the same as (n1) described above, but is preferably N.

Therefore, more preferred aspects of the heterocyclic compound having the formula (n2) include a heterocyclic compound having the following formula (n3).

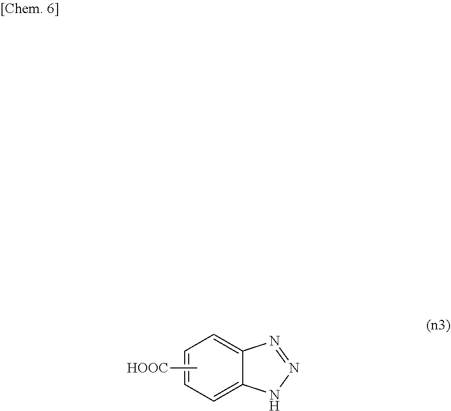

Specific examples of the heterocyclic compound having the formula (n3) include carboxy benzotriazole, 5-carboxy benzotriazole, and 4-carboxybenzotriazole, and carboxy benzotriazole and 5-carboxybenzotriazole are preferable.

The content of the nitrogen-containing heterocyclic compound is preferably 0.05 to 200 parts by weight, more preferably 0.1 to 150 parts by weight, still more preferably 5 to 130 parts by weight, still even more preferably 10 to 110 parts by weight, and most preferably 10 to 100 parts by weight per 100 parts by weight of the conductive carbon material. The nitrogen-containing heterocyclic compounds may be used singly or in combination of two or more kinds thereof.

The dispersant can be appropriately selected from those conventionally used as dispersants for conductive carbon materials such as CNTs, and examples thereof include carboxymethyl cellulose (CMC), polyvinyl pyrrolidone (PVP), acrylic resin emulsions, water-soluble acrylic polymers, styrene emulsions, silicon emulsions, acrylic silicon emulsions, fluororesin emulsions, EVA emulsions, vinyl acetate emulsions, vinyl chloride emulsions, urethane resin emulsions, a triarylamine-based highly branched polymer described in WO 2014/042080, and a pendant oxazoline group-containing polymer described in WO 2015/029949. In the present invention, a dispersant including a pendant oxazoline group-containing polymer is preferably used from the viewpoint of ensuring a migration suppression effect and improving adhesion between a current collector and an undercoat layer.

The pendant oxazoline group-containing polymer (hereinafter, referred to as oxazoline polymer) is preferably a pendant oxazoline group-containing vinyl-based polymer that is obtained by radical polymerization of an oxazoline monomer of formula (1) having a polymerizable carbon-carbon double bond-containing group at the second position and has repeating units that are bonded at the second position of the oxazoline ring to the polymer main chain or to spacer groups.

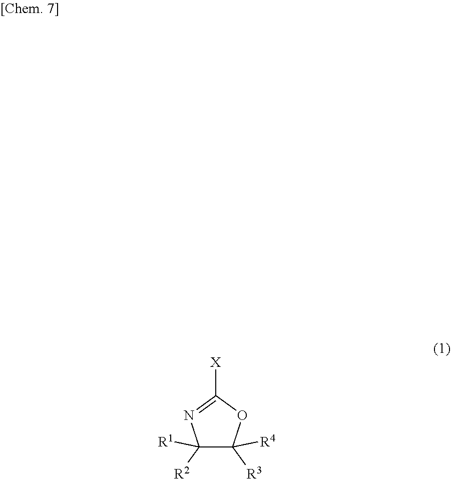

X represents a polymerizable carbon-carbon double bond-containing group, and R¹ to R⁴ each independently represent a hydrogen atom, a halogen atom, an alkyl group having 1 to 5 carbon atoms, an aryl group having 6 to 20 carbon atoms, or an aralkyl group having 7 to 20 carbon atoms.

The polymerizable carbon-carbon double bond-containing group of the oxazoline monomer is not particularly limited as long as the group contains a polymerizable carbon-carbon double bond, but a chain hydrocarbon group containing a polymerizable carbon-carbon double bond is preferable. For example, alkenyl groups having 2 to 8 carbon atoms such as a vinyl group, an allyl group, and an isopropenyl group are preferable. Examples of the halogen atom include a fluorine atom, a chlorine atom, a bromine atom, and an iodine atom. The alkyl group having 1 to 5 carbon atoms may be linear, branched, or cyclic, and examples of the alkyl group include a methyl group, an ethyl group, an n-propyl group, an isopropyl group, an n-butyl group, a sec-butyl group, a tert-butyl group, an n-pentyl group, and a cyclohexyl group. Examples of the aryl group having 6 to 20 carbon atoms include a phenyl group, a xylyl group, a tolyl group, a biphenyl group, and a naphthyl group. Examples of the aralkyl group having 7 to 20 carbon atoms include a benzyl group, a phenylethyl group, and a phenylcyclohexyl group.

Examples of the oxazoline monomer of formula (1) having a polymerizable carbon-carbon double bond-containing group at the second position include 2-vinyl-2-oxazoline, 2-vinyl-4-methyl-2-oxazoline, 2-vinyl-4-ethyl-2-oxazoline, 2-vinyl-4-propyl-2-oxazoline, 2-vinyl-4-butyl-2-oxazoline, 2-vinyl-5-methyl-2-oxazoline, 2-vinyl-5-ethyl-2-oxazoline, 2-vinyl-5-propyl-2-oxazoline, 2-vinyl-5-butyl-2-oxazoline, 2-isopropenyl-2-oxazoline, 2-isopropenyl-4-methyl-2-oxazoline, 2-isopropenyl-4-ethyl-2-oxazoline, 2-isopropenyl-4-propyl-2-oxazoline, 2-isopropenyl-4-butyl-2-oxazoline, 2-isopropenyl-5-methyl-2-oxazoline, 2-isopropenyl-5-ethyl-2-oxazoline, 2-isopropenyl-5-propyl-2-oxazoline, and 2-isopropenyl-5-butyl-2-oxazoline, and 2-isopropenyl-2-oxazoline is preferable from the viewpoint of availability and the like.

In consideration that an aqueous solvent is used for preparing a composition, the oxazoline polymer is also preferably water-soluble. Such a water-soluble oxazoline polymer may be a homopolymer of the oxazoline monomer of formula (1), but in order to further enhance the solubility in water, the water-soluble oxazoline polymer is preferably obtained by radical polymerization of at least two monomers including the oxazoline monomer and a (meth)acrylic acid ester-based monomer having a hydrophilic functional group.

Examples of the (meth)acrylic monomer having a hydrophilic functional group include (meth)acrylic acid, 2-hydroxyethyl acrylate, methoxy polyethylene glycol acrylate, monoesters of acrylic acid with polyethylene glycol, 2-aminoethyl acrylate and its salts, 2-hydroxyethyl methacrylate, methoxy polyethylene glycol methacrylate, monoesters of methacrylic acid with polyethylene glycol, 2-aminoethyl methacrylate and its salts, sodium (meth)acrylate, ammonium (meth)acrylate, (meth)acrylonitrile, (meth)acrylamide, N-methylol (meth)acrylamide, N-(2-hydroxyethyl) (meth)acrylamide, and sodium styrenesulfonate. These may be used singly or in combination of two or more kinds thereof. Among them, methoxy polyethylene glycol (meth)acrylate and monoesters of (meth)acrylic acid with polyethylene glycol are suitable.

In addition to the oxazoline monomer and the (meth)acrylic monomer having a hydrophilic functional group, other monomers can be used in combination as long as the ability of the oxazoline polymer to disperse the conductive carbon material such as a CNT is not adversely affected. Examples of such other monomers include (meth)acrylic acid ester monomers such as methyl (meth)acrylate, ethyl (meth)acrylate, butyl (meth)acrylate, 2-ethylhexyl (meth)acrylate, stearyl (meth)acrylate, perfluoroethyl (meth)acrylate, and phenyl (meth)acrylate, olefin-based monomers such as ethylene, propylene, butene, and pentene, haloolefin-based monomers such as vinyl chloride, vinylidene chloride, and vinyl fluoride, styrene-based monomers such as styrene and α-methylstyrene, vinyl carboxylate-based monomers such as vinyl acetate and vinyl propionate, and vinyl ether-based monomers such as methyl vinyl ether and ethyl vinyl ether. These may be used singly or in combination of two or more kinds thereof.

In the monomer components used for manufacturing the oxazoline polymer used in the present invention, the content of the oxazoline monomer is preferably 10 wt % or more, more preferably 20 wt % or more, and still more preferably 30 wt % or more from the viewpoint of further enhancing the ability of the resulting oxazoline polymer to disperse the conductive carbon material such as a CNT. The upper limit of the content of the oxazoline monomer in the monomer components is 100 wt %, and if the content is 100 wt %, a homopolymer of the oxazoline monomer is obtained.

Meanwhile, from the viewpoint of further enhancing the water solubility of the resulting oxazoline polymer, the content of the (meth)acrylic monomer having a hydrophilic functional group in the monomer components is preferably 10 wt % or more, more preferably 20 wt % or more, and still more preferably 30 wt % or more.

As described above, the content of other monomers in the monomer components is in a range in which the ability of the resulting oxazoline polymer to disperse the conductive carbon material such as a CNT is not affected, and the content depends on the kinds of monomers. Therefore, the content cannot be strictly specified, but is to be suitably set preferably in the range of 5 to 95 wt %, and more preferably 10 to 90 wt %.

The average molecular weight of the oxazoline polymer is not particularly limited, but the weight average molecular weight is preferably 1,000 to 2,000,000, and more preferably 2,000 to 1,000,000. The weight average molecular weight is a polystyrene-equivalent value obtained by gel permeation chromatography.

The oxazoline polymer that may be used in the present invention can be synthesized by a known radical polymerization of the above monomers, or can be acquired as a commercially available product. Examples of such a commercially available product include EPOCROS WS-300 (manufactured by NIPPON SHOKUBAI CO., LTD., solid content concentration: 10 wt %, aqueous solution), EPOCROS WS-700 (manufactured by NIPPON SHOKUBAI CO., LTD., solid content concentration: 25 wt %, aqueous solution), EPOCROS WS-500 (manufactured by NIPPON SHOKUBAI CO., LTD., solid content concentration: 39 wt %, water/1-methoxy-2-propanol solution), Poly(2-ethyl-2-oxazoline) (Aldrich), Poly(2-ethyl-2-oxazoline) (Alfa Aesar), and Poly(2-ethyl-2-oxazoline) (VWR International, LLC).

An oxazoline polymer that is commercially available in the form of a solution may be used as it is, or may be used after replacing the solvent with a target solvent.

Suitable use can be made of triarylamine-based highly branched polymers of formulas (2) and (3) described below obtained by condensation polymerization of a triarylamine with an aldehyde and/or a ketone under acidic conditions.

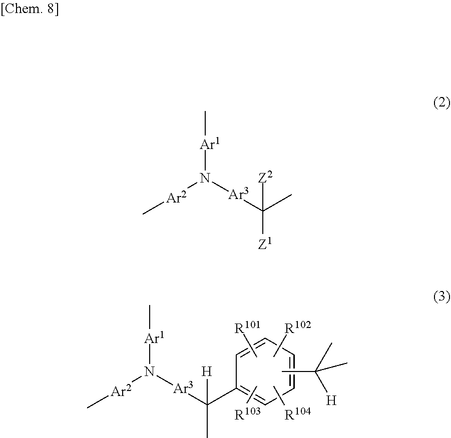

In the above-described formulas (2) and (3), Ar¹ to Ar³ each independently represent any of divalent organic groups of formulas (4) to (8), and a substituted or unsubstituted phenylene group of formula (4) is particularly preferable.

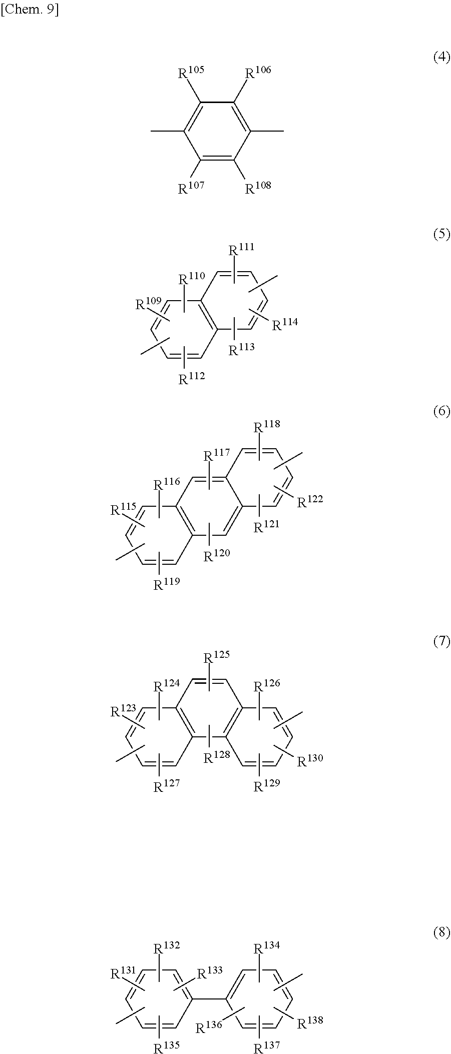

In formulas (2) and (3), Z¹ and Z² each independently represent a hydrogen atom, a linear or branched alkyl group having 1 to 5 carbon atoms, or any of monovalent organic groups of formulas (9) to (12) (provided that Z¹ and Z² do not represent the alkyl group at the same time).

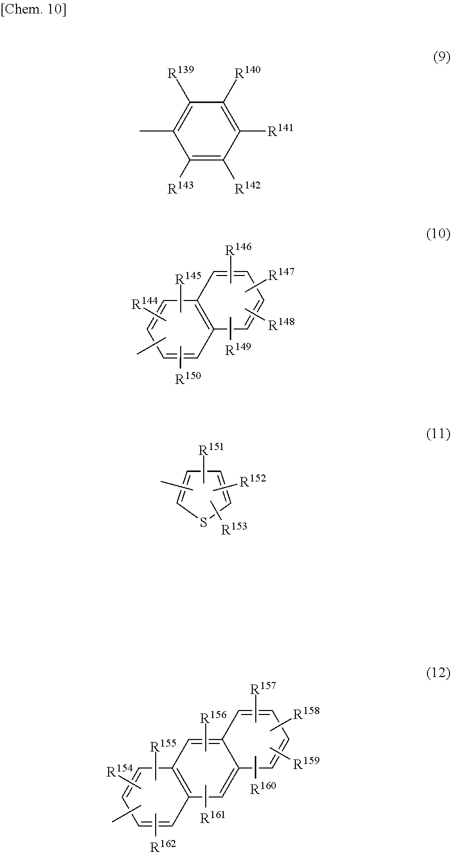

In the above-described formulas (3) to (8), R¹⁰¹ to R¹³⁸ each independently represent a hydrogen atom, a halogen atom, a linear or branched alkyl group having 1 to 5 carbon atoms, a linear or branched alkoxy group having 1 to 5 carbon atoms, a carboxyl group, a sulfo group, a phosphate group, a phosphonic acid group, or a salt thereof.

Examples of the halogen atom include a fluorine atom, a chlorine atom, a bromine atom, and an iodine atom.

Examples of the linear or branched alkyl group having 1 to 5 carbon atoms include a methyl group, an ethyl group, an n-propyl group, an isopropyl group, an n-butyl group, a sec-butyl group, a tert-butyl group, and an n-pentyl group.

Examples of the linear or branched alkoxy group having 1 to 5 carbon atoms include a methoxy group, an ethoxy group, an n-propoxy group, an isopropoxy group, an n-butoxy group, a sec-butoxy group, a tert-butoxy group, and an n-pentoxy group.

Examples of the salts of a carboxyl group, a sulfo group, a phosphate group, and a phosphonic acid group include salts of alkali metals such as sodium and potassium, salts of Group 2 metals such as magnesium and calcium, ammonium salts, salts of aliphatic amines such as propylamine, dimethylamine, triethylamine, and ethylenediamine, salts of alicyclic amines such as imidazoline, piperazine, and morpholine, salts of aromatic amines such as aniline and diphenylamine, and pyridinium salts.

In the above-described formulas (9) to (12), R¹³⁹ to R¹⁶² each independently represent a hydrogen atom, a halogen atom, a linear or branched alkyl group having 1 to 5 carbon atoms, a linear or branched haloalkyl group having 1 to 5 carbon atoms, a phenyl group, OR¹⁶³, COR¹⁶³, NR¹⁶³R¹⁶⁴, COOR165 (wherein R¹⁶³ and R¹⁶⁴ each independently represent a hydrogen atom, a linear or branched alkyl group having 1 to 5 carbon atoms, a linear or branched haloalkyl group having 1 to 5 carbon atoms, or a phenyl group, and R¹⁶⁵ represents a linear or branched alkyl group having 1 to 5 carbon atoms, a linear or branched haloalkyl group having 1 to 5 carbon atoms, or a phenyl group), a carboxyl group, a sulfo group, a phosphate group, a phosphonic acid group, or a salt thereof.

Here, examples of the linear or branched haloalkyl group having 1 to 5 carbon atoms include a difluoromethyl group, a trifluoromethyl group, a bromodifluoromethyl group, a 2-chloroethyl group, a 2-bromoethyl group, a 1,1-difluoroethyl group, a 2,2,2-trifluoroethyl group, a 1,1,2,2-tetrafluoroethyl group, a 2-chloro-1,1,2-trifluoroethyl group, a pentafluoroethyl group, a 3-bromopropyl group, a 2,2,3,3-tetrafluoropropyl group, a 1,1,2,3,3,3-hexafluoropropyl group, a 1,1,1,3,3,3-hexafluoropropane-2-yl group, a 3-bromo-2-methylpropyl group, a 4-bromobutyl group, and a perfluoropentyl group.

Examples of the halogen atom and the linear or branched alkyl group having 1 to 5 carbon atoms include the same groups as those described above as examples in formulas (3) to (8).

Z¹ and Z² are each independently preferably a hydrogen atom, a 2- or 3-thienyl group, or a group of formula (9), and it is particularly preferable that one of Z¹ and Z² be a hydrogen atom and the other be a hydrogen atom, a 2- or 3-thienyl group, or a group of formula (9), and in particular, it is more preferable that R¹⁴¹ be a phenyl group or R¹⁴¹ be a methoxy group.

In a case where R¹⁴¹ is a phenyl group and the acidic group insertion method described below is used in which an acidic group is inserted after manufacturing a polymer, an acidic group may be inserted onto this phenyl group.

In particular in consideration of further improving the adhesion to the current collector, the highly branched polymer preferably has at least one acidic group selected from a carboxyl group, a sulfo group, a phosphate group, a phosphonic acid group, and salts thereof in at least one aromatic ring in the repeating units of formula (2) or (3), and more preferably has a sulfo group or its salt.

Examples of the aldehyde compound used for manufacturing the highly branched polymer include saturated aliphatic aldehydes such as formaldehyde, paraformaldehyde, acetaldehyde, propylaldehyde, butyraldehyde, isobutyraldehyde, valeraldehyde, capronaldehyde, 2-methylbutyraldehyde, hexylaldehyde, undecylaldehyde, 7-methoxy-3,7-dimethyloctylaldehyde, cyclohexanecarboxy aldehyde, 3-methyl-2-butyraldehyde, glyoxal, malonaldehyde, succinaldehyde, glutaraldehyde, and adipinaldehyde, unsaturated aliphatic aldehydes such as acrolein and methacrolein, heterocyclic aldehydes such as furfural, pyridinealdehyde, and thiophenealdehyde, aromatic aldehydes such as benzaldehyde, tolylaldehyde, trifluoromethylbenzaldehyde, phenylbenzaldehyde, salicylaldehyde, anisaldehyde, acetoxy benzaldehyde, terephthalaldehyde, acetylbenzaldehyde, formylbenzoic acid, methyl formylbenzoate, aminobenzaldehyde, N,N-dimethylaminobenzaldehyde, N,N-diphenylaminobenzaldehyde, naphthylaldehyde, anthrylaldehyde, and phenanthrylaldehyde, and aralkyl aldehydes such as phenylacetaldehyde and 3-phenylpropionaldehyde. Among them, aromatic aldehydes are preferably used.

The ketone compound used for manufacturing the highly branched polymer is an alkyl aryl ketone or a diaryl ketone, and examples of the ketone include acetophenone, propiophenone, diphenyl ketone, phenyl naphthyl ketone, dinaphthyl ketone, phenyl tolyl ketone, and ditolyl ketone.

The highly branched polymer used in the present invention can be manufactured, for example, according to the method described in WO 2014/042080.

The average molecular weight of the highly branched polymer is not particularly limited, but the weight average molecular weight is preferably 1,000 to 2,000,000, and more preferably 2,000 to 1,000,000.

Specific examples of the highly branched polymer include, but are not limited to, those represented by the following formula.

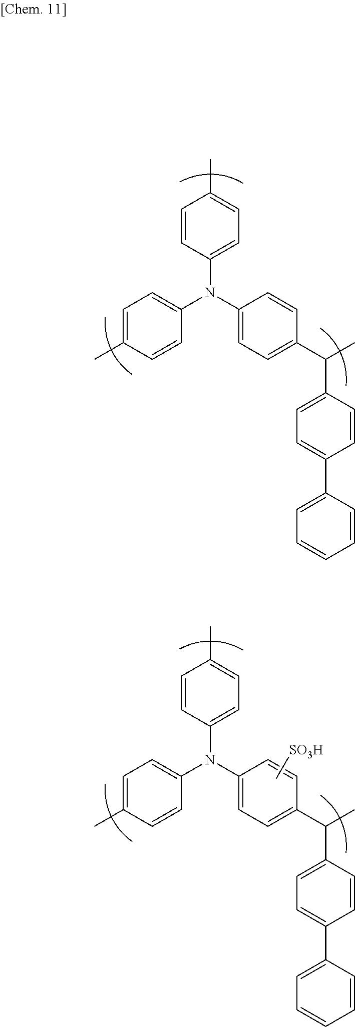

In the present invention, the conductive carbon material and the dispersant can be mixed at a ratio by weight of about 1,000:1 to 1:100.

The amount of the dispersant added is not particularly limited as long as the concentration of the dispersant is such that the conductive carbon material can be dispersed in the solvent, but is preferably 5 to 700 parts by weight, more preferably 10 to 500 parts by weight, and still more preferably 20 to 300 parts by weight per 100 parts by weight of the conductive carbon material.

As long as an effect of the present invention is not impaired, the composition of the present invention may include a crosslinking agent that causes a crosslinking reaction with the dispersant to be used, or may include a self-crosslinking agent. These crosslinking agents are preferably dissolved in a solvent to be used.

Examples of the crosslinking agent of the triarylamine-based highly branched polymer include melamine-based crosslinking agents, substituted urea-based crosslinking agents, and polymer-based crosslinking agents including a polymer of melamine or substituted urea. These crosslinking agents may be used singly, or in combination of two or more kinds thereof. A crosslinking agent having at least two crosslink-forming substituents is preferred, and examples of such a crosslinking agent include compounds such as CYMEL (registered trademark), methoxymethylated glycoluril, butoxymethylated glycoluril, methylolated glycoluril, methoxymethylated melamine, butoxymethylated melamine, methylolated melamine, methoxymethylated benzoguanamine, butoxy methylated benzoguanamine, methylolated benzoguanamine, methoxymethylated urea, butoxymethylated urea, methylolated urea, methoxy methylated thiourea, methoxy methylated thiourea, and methylolated thiourea, and condensates of these compounds.

The crosslinking agent of the oxazoline polymer is not particularly limited as long as the crosslinking agent is a compound having two or more functional groups that react with oxazoline groups, such as carboxyl, hydroxyl, thiol, amino, sulfinic acid, and epoxy groups, but a compound having two or more carboxyl groups is preferable. As the crosslinking agent, a compound can be used that has functional groups that generate, under heating during thin-film formation or in the presence of an acid catalyst, the functional groups described above to cause crosslinking reactions, and examples of such a compound include compounds having a sodium salt, a potassium salt, a lithium salt, an ammonium salt, or the like of carboxylic acid.

Specific examples of the compound that causes a crosslinking reaction with an oxazoline group include metal salts that exhibit crosslinking reactivity in the presence of an acid catalyst, including metal salts of synthetic polymers such as polyacrylic acid and copolymers thereof and metal salts of natural polymers such as carboxymethylcellulose and alginic acid, and include ammonium salts that exhibit crosslinking reactivity under heating, including ammonium salts of the above-described synthetic polymers and natural polymers. In particular, sodium polyacrylate, lithium polyacrylate, ammonium polyacrylate, carboxy methylcellulose sodium, carboxymethylcellulose lithium, carboxymethylcellulose ammonium, and the like, which exhibit crosslinking reactivity in the presence of an acid catalyst or under heating conditions, are preferable.

Such a compound that causes a crosslinking reaction with an oxazoline group can be acquired as a commercially available product. Examples of the commercially available product include sodium polyacrylate (manufactured by FUJIFILM Wako Pure Chemical Corporation, degree of polymerization: 2,700 to 7,500), carboxymethylcellulose sodium (manufactured by FUJIFILM Wako Pure Chemical Corporation), sodium alginate (manufactured by KANTO CHEMICAL CO., INC., Cica first grade), Aron A-30 (ammonium polyacrylate, manufactured by Toagosei Co., Ltd., solid content concentration: 32 wt %, aqueous solution), DN-800H (carboxymethylcellulose ammonium, manufactured by Daicel FineChem Ltd.) and ammonium alginate (manufactured by KIMICA Corporation).

Examples of the self-crosslinking agent include compounds having, on the same molecule, crosslinkable functional groups that react with one another, such as a hydroxyl group with an aldehyde group, epoxy group, vinyl group, isocyanate group, or alkoxy group, a carboxyl group with an aldehyde group, amino group, isocyanate group, or epoxy group, or an amino group with an isocyanate group or aldehyde group, and compounds having like crosslinkable functional groups that react with one another, such as hydroxyl groups (dehydration condensation), mercapto groups (disulfide bonding), ester groups (Claisen condensation), silanol groups (dehydration condensation), vinyl groups, or acrylic groups.

Specific examples of the self-crosslinking agent include self-crosslinking agents that exhibit crosslinking reactivity in the presence of an acid catalyst, such as polyfunctional acrylates, tetraalkoxysilanes, and block copolymers of a blocked isocyanate group-containing monomer and a monomer having at least one of a hydroxyl group, carboxylic acid, or an amino group.

Such a self-crosslinking agent can be acquired as a commercially available product. Examples of the commercially available product include polyfunctional acrylates such as A-9300 (ethoxylated isocyanuric acid triacrylate, manufactured by SHIN-NAKAMURA CHEMICAL Co., Ltd.), A-GLY-9E (Ethoxylated glycerine triacrylate (EO 9 mol), manufactured by SHIN-NAKAMURA CHEMICAL Co., Ltd.), and A-TMMT (pentaery thritol tetraacrylate, manufactured by SHIN-NAKAMURA CHEMICAL Co., Ltd.), tetraalkoxysilanes such as tetramethoxysilane (manufactured by Tokyo Chemical Industry Co., Ltd.) and tetraethoxysilane (manufactured by Toyoko Kagaku Co., Ltd.), and blocked isocyanate group-containing polymers such as the ELASTRON series E-37, H-3, H38, BAP, NEW BAP-15, C-52, F-29, W-11P, MF-9, and MF-25K (manufactured by DKS Co., Ltd.).

In the case of adding a crosslinking agent, the amount of the crosslinking agent depends on the solvent to be used, the substrate to be used, the required viscosity, the required film shape, and the like, and is preferably 5 to 1,000 parts by weight, more preferably 10 to 800 parts by weight, and still more preferably 20 to 500 parts by weight per 100 parts by weight of the conductive carbon material. Although these crosslinking agents may cause a crosslinking reaction by self-condensation, they cause a crosslinking reaction with the dispersant, and in a case where a crosslinkable substituent is present in the dispersant, the crosslinkable substituent promotes the crosslinking reaction.

The solvent used for preparing the composition of the present invention is not particularly limited, and examples of the solvent include water and hydrophilic solvents. Hydrophilic solvents are organic solvents that arbitrarily mix with water, and examples thereof include organic solvents including ethers such as tetrahydrofuran (THF), amides such as N,N-dimethylformamide (DMF), N,N-dimethylacetamide (DMAc), and N-methyl-2-pyrrolidone (NMP), ketones such as acetone, alcohols such as methanol, ethanol, n-propanol, and 2-propanol, glycol ethers such as ethylene glycol monoethyl ether, ethylene glycol monobutyl ether, and propylene glycol monomethyl ether, and glycols such as ethylene glycol and propylene glycol. These solvents may be used singly or in combination of two or more kinds thereof. In the case of using a CNT as the conductive carbon material, particularly preferable solvents are water, NMP, DMF, THF, methanol, ethanol, n-propanol, 2-propanol, n-butanol, and t-butanol from the viewpoint of increasing the proportion of the CNT discretely dispersed. From the viewpoint of improving the coatability, solvents preferably included are methanol, ethanol, n-propanol, 2-propanol, n-butanol, t-butanol, and ethylene glycol monobutyl ether. From the viewpoint of lowering the cost, water is preferably included. These solvents can be used singly or in combination of two or more kinds thereof for the purpose of increasing the proportion of discrete dispersion, improving the coatability, and lowering the cost.

A polymer that serves as a matrix may be added to the composition of the present invention. Examples of the matrix polymer include thermoplastic resins including fluorine-based resins such as polyvinylidene fluoride (PVdF), polytetrafluoroethylene, tetrafluoroethylene-hexafluoropropylene copolymers, vinylidene fluoride-hexafluoropropylene copolymers [P(VDF-HFP)], and vinylidene fluoride-chlorotrifluoroethylene copolymers [P(VDF-CTFE)], polyolefin-based resins such as polyvinylpyrrolidone, ethylene-propylene-diene ternary copolymers, polyethylene (PE), polypropylene (PP), ethylene-vinyl acetate copolymers (EVA), and ethylene-ethyl acrylate copolymers (EEA), polystyrene-based resins such as polystyrene (PS), high-impact polystyrene (HIPS), acrylonitrile-styrene copolymers (AS), acrylonitrile-butadiene-styrene copolymers (ABS), methyl methacrylate-styrene copolymers (MS), and styrene-butadiene rubber, polycarbonate resins, vinyl chloride resins, polyamide resins, polyimide resins, (meth)acrylic resins such as sodium polyacrylate and polymethyl methacrylate (PMMA), polyester resins such as polyethylene terephthalate (PET), poly butylene terephthalate, polyethylene naphthalate, poly butylene naphthalate, polylactic acid (PLA), poly-3-hydroxy butyric acid, polycaprolactone, polybutylene succinate, and polyethylene succinate/adipate, polyphenylene ether resins, modified polyphenylene ether resins, polyacetal resins, polysulfone resins, polyphenylene sulfide resins, polyvinyl alcohol resins, polyglycolic acids, modified starches, cellulose acetate, carboxymethylcellulose, cellulose triacetate, chitin, chitosan, and lignin: electrically conductive polymers including polyaniline and emeraldine base as the semi-oxidized form of polyaniline, polythiophene, polypyrrole, polyphenylene vinylene, polyphenylene, and polyacetylene; and thermosetting resins and photo-curing resins including epoxy resins, urethane acrylate, phenolic resins, melamine resins, urea resins, and alkyd resins. Among them, polymers that are also water-soluble in the form of a matrix polymer are suitable because in the conductive carbon material dispersion of the present invention, water is preferably used as the solvent. Examples of such polymers include sodium polyacrylate, carboxymethylcellulose sodium, water-soluble cellulose ether, sodium alginate, polyvinyl alcohol, polystyrene sulfonic acid, and polyethylene glycol, and polyacrylic acid, carboxymethylcellulose sodium, and the like are particularly suitable.

The matrix polymer can be acquired as a commercially available product. Examples of the commercially available product include sodium polyacrylate (manufactured by FUJIFILM Wako Pure Chemical Corporation, degree of polymerization: 2,700 to 7,500), carboxymethylcellulose sodium (manufactured by FUJIFILM Wako Pure Chemical Corporation), sodium alginate (manufactured by KANTO CHEMICAL CO., INC., Cica first grade), the METOLOSE SH series (hydroxypropylmethyl cellulose, manufactured by Shin-Etsu Chemical Co., Ltd.), the METOLOSE SE series (hydroxyethylmethyl cellulose, manufactured by Shin-Etsu Chemical Co., Ltd.), JC-25 (a fully saponified polyvinyl alcohol, manufactured by JAPAN VAM & POVAL CO., LTD.), JM-17 (an intermediately saponified polyvinyl alcohol, manufactured by JAPAN VAM & POVAL CO., LTD.), JP-03 (a partially saponified polyvinyl alcohol, manufactured by JAPAN VAM & POVAL CO., LTD.), and polystyrene sulfonic acid (manufactured by Aldrich, solid content concentration: 18 wt %, aqueous solution).

In the case of adding a matrix polymer, the amount of the matrix polymer added is not particularly limited, but is preferably about 0.0001 to 99 wt %, and more preferably about 0.001 to 90 wt % in the composition.

The method of preparing the composition of the present invention is not particularly limited, and a dispersion is to be prepared by mixing a conductive carbon material, a nitrogen-containing heterocyclic compound, a dispersant, a solvent, a matrix polymer used as necessary, and the like in any order. Furthermore, the mixture is preferably subjected to dispersion treatment, and this treatment can increase the proportion of the conductive carbon material dispersed. Examples of the dispersion treatment include mechanical treatment including wet treatment using a ball mill, a bead mill, a jet mill, or the like and ultrasonic treatment using a bath-type or probe-type sonicator, and wet treatment using a jet mill and ultrasonic treatment are suitable.

The dispersion treatment may be performed for an optional time, but the time is preferably about 1 minute to 10 hours, and more preferably about 5 minutes to 5 hours. At this time, heating treatment or cooling treatment may be performed as necessary.

In the case of using optional components such as a matrix polymer, the optional components may be added after preparing a mixture including a conductive carbon material, a nitrogen-containing heterocyclic compound, a dispersant, and a solvent.

In the present invention, the solid content concentration of the composition is not particularly limited, but is preferably 20 wt % or less, more preferably 15 wt % or less, still more preferably 10 wt % or less, and still even more preferably 5 wt % or less in consideration of forming an undercoat layer with a desired coating weight and film thickness. The solid content concentration may have any lower limit, but the lower limit is preferably 0.1 wt % or more, more preferably 0.5 wt % or more, and still more preferably 1 wt % or more from a practical viewpoint.

The solid content is the total amount of the components, other than the solvent, included in the composition.

The above-described composition is applied to at least one side of a current collector and dried naturally or by heating to form an undercoat layer, and thus an undercoat foil (composite current collector) can be produced.

As the current collector, a current collector can be used that is conventionally used in an electrode for energy storage devices. Examples of the usable current collector include copper, aluminum, titanium, stainless steel, nickel, gold, silver, alloys thereof, carbon materials, metal oxides, and conductive polymers. In the present invention, a migration suppression effect can be further exhibited in the case of using a metal foil made of copper, aluminum, nickel, or an alloy thereof. The thickness of the current collector is not particularly limited, but is preferably 1 to 100 μm in the present invention.

Examples of the method of applying the composition include a spin coating method, a dip coating method, a flow coating method, an inkjet method, a casting method, a spray coating method, a bar coating method, a gravure coating method, a slit coating method, a roll coating method, a flexographic printing method, a transfer printing method, brush coating, a blade coating method, an air knife coating method, and a die coating method. From the viewpoint of work efficiency and the like, suitable methods are an inkjet coating method, a casting method, a dip coating method, a bar coating method, a blade coating method, a roll coating method, a gravure coating method, a flexographic printing method, a spray coating method, and a die coating method. The heating and drying may be performed at an optional temperature, but the temperature is preferably about 50 to 200° C., and more preferably about 80 to 150° C.

The thickness of the undercoat layer is preferably 1 nm to 10 μm, more preferably 1 nm to 1 μm, and still more preferably 1 to 500 nm in consideration of reducing the internal resistance of a device to be obtained. The thickness of the undercoat layer can be determined by, for example, cutting out a test specimen having a suitable size from the undercoat foil, exposing the section of the specimen with a method such as tearing the specimen by hand, and observing the sectional portion where the undercoat layer is exposed with a scanning electron microscope (SEM) or the like.

The coating weight of the undercoat layer per side of the current collector is not particularly limited as long as the above-described film thickness is satisfied, but is preferably 2,000 mg/m² or less, more preferably 1,000 mg/m² or less, still more preferably 800 mg/m² or less, and still even more preferably 500 mg/m² or less. Meanwhile, in order to ensure the function of the undercoat layer and obtain a battery having excellent characteristics with good reproducibility, the coating weight of the undercoat layer per side of the current collector is preferably 1 mg/m² or more, more preferably 5 mg/m² or more, still more preferably 10 mg/m² or more, and still even more preferably 15 mg/m² or more.

The coating weight of the undercoat layer refers to the ratio of the weight (mg) of the undercoat layer to the area (m²) of the undercoat layer. In the case of an undercoat layer formed in a pattern, the area of the undercoat layer is the area of the undercoat layer alone and does not include the area of the current collector exposed within the undercoat layer formed in the pattern.

The weight of the undercoat layer can be determined by, for example, cutting out a test specimen having a suitable size from the undercoat foil and measuring the weight of the specimen (W0), then stripping the undercoat layer from the undercoat foil and measuring the weight after the stripping of the undercoat layer (W1), and calculating the difference between W0 and W1 (W0-W1). Alternatively, the weight of the undercoat layer can be determined by measuring the weight of the current collector (W2) in advance, then measuring the weight of the undercoat foil after forming the undercoat layer (W3), and calculating the difference between W2 and W3 (W3−W2). Examples of the method of stripping the undercoat layer include a method in which the undercoat layer is immersed in a solvent that dissolves or swells the undercoat layer, and wiped off with a cloth or the like.

The coating weight and the film thickness can be adjusted with a known method. For example, in the case of forming an undercoat layer by coating, the coating weight and the film thickness can be adjusted by varying the solid content concentration of the coating slurry used to form the undercoat layer (composition for formation of the undercoat layer), the number of coating passes, the clearance of the coating slurry delivery opening in the coater, or the like. When the coating weight and the film thickness are to be increased, the solid content concentration, the number of coating passes, or the clearance is increased. When the coating weight and the film thickness are to be reduced, the solid content concentration, the number of coating passes, or the clearance is reduced.

The electrode for energy storage devices of the present invention can be produced by forming an electrode mixture layer on the undercoat layer. Examples of the energy storage device in the present invention include various energy storage devices including electrical double-layer capacitors, lithium secondary batteries, lithium-ion secondary batteries, proton polymer batteries, nickel-hydrogen batteries, aluminum solid capacitors, electrolytic capacitors, and lead storage batteries. The undercoat foil of the present invention can be particularly suitably used in electrical double-layer capacitors and lithium-ion secondary batteries.

The electrode mixture layer can be formed by applying an electrode slurry produced by mixing an active material, a binder polymer, and if necessary, a solvent to the undercoat layer, and drying the electrode slurry naturally or by heating.

As the active material, various active materials can be used that are conventionally used in an electrode for energy storage devices. In the case of lithium secondary batteries and lithium-ion secondary batteries, compounds capable of intercalating and deintercalating lithium ions can be used as the positive electrode active material, and examples of such compounds include chalcogen compounds, lithium ion-containing chalcogen compounds, polyanionic compounds, elemental sulfur, and sulfur compounds.

Examples of the chalcogen compounds capable of intercalating and deintercalating lithium ions include FeS₂, TiS₂, MoS₂, V₂O₆, V₆O₁₃, and MnO₂.

Examples of the lithium ion-containing chalcogen compounds include LiCoO₂, LiMnO₂, LiMn₂O₄, LiMo₂O₄, LiV₃O₈, LiNiO₂, and LiₓNi_{y}M_{1-y}O₂ (provided that M represents at least one metal element selected from Co, Mn, Ti, Cr, V, Al, Sn, Pb, and Zn, 0.05≤x≤1.10, and 0.5≤y≤1.0).

Examples of the polyanionic compounds include LiFePO₄.

Examples of the sulfur compounds include Li₂S and rubeanic acid.

As the negative electrode active material included in the negative electrode, the following materials can be used: alkali metals, alkali alloys, at least one elemental substance selected from Group 4 to Group 15 elements in the periodic table that intercalate and deintercalate lithium ions, and oxides, sulfides, and nitrides of the at least one elemental substance, and carbon materials capable of reversibly intercalating and deintercalating lithium ions.

Examples of the alkali metals include Li, Na, and K, and examples of the alkali metal alloys include Li—Al, Li—Mg, Li—Al—Ni, Na—Hg, and Na—Zn.

Examples of the at least one elemental substance selected from Group 4 to Group 15 elements in the periodic table that intercalate and deintercalate lithium ions include silicon, tin, aluminum, zinc, and arsenic.

Examples of the oxides of the at least one elemental substance include silicon monoxide (SiO), silicon dioxide (SiO₂), tin silicon oxide (SnSiO₃), lithium bismuth oxide (Li₃BiO₄), lithium zinc oxide (Li₂ZnO₂), lithium titanium oxide (Li₄Ti₅O₁₂), and titanium oxide.

Examples of the sulfides of the at least one elemental substance include lithium iron sulfides (LiₓFeS₂ (0≤x≤3)) and lithium copper sulfides (LiₓCuS (0≤x≤3)).

Examples of the nitrides of the at least one elemental substance include lithium-containing transition metal nitrides, and specific examples thereof include LiₓM_{y}N (M=Co, Ni, Cu, 0≤x≤3, 0≤y≤0.5) and lithium iron nitride (Li₃FeN₄).

Examples of the carbon materials capable of reversibly intercalating and deintercalating lithium ions include graphite, carbon black, coke, glassy carbon, carbon fibers, carbon nanotubes, and sintered bodies thereof.

In the case of an electrical double-layer capacitor, a carbonaceous material can be used as the active material.

Examples of the carbonaceous material include activated carbon, including activated carbon obtained by carbonizing a phenol resin and then subjecting the resulting carbonized resin to activation treatment.

The binder polymer can be appropriately selected for use from known materials, and examples of the binder polymer include polyvinylidene fluoride (PVdF), polyvinylpyrrolidone, polytetrafluoroethylene, tetrafluoroethylene-hexafluoropropylene copolymers, vinylidene fluoride-hexafluoropropylene copolymers [P(VDF-HFP)], vinylidene fluoride-chlorotrifluoroethylene copolymers [P(VDF-CTFE)], polyvinyl alcohols, polyimides, ethylene-propylene-diene ternary copolymers, styrene-butadiene rubber, carboxymethylcellulose (CMC), polyacrylic acid (PAA), polyaniline, polyimides, and polyamides. The amount of the binder polymer added is preferably 0.1 to 40 parts by weight, and particularly preferably 1 to 30 parts by weight per 100 parts by weight of the active material.

The solvent is exemplified by the solvents described as examples of the solvent for the composition, and is to be appropriately selected from them according to the kind of the binder, but NMP is suitable in the case of a water-insoluble binder such as PVdF, and water is suitable in the case of a water-soluble binder such as PAA.

The electrode slurry may contain a conductive material. Examples of the conductive material include carbon black, Ketjen black, acetylene black, carbon whiskers, carbon fibers, natural graphite, synthetic graphite, titanium oxide, ruthenium oxide, aluminum, and nickel.

Examples of the method of applying the electrode slurry include the same methods as those described above as examples of the method of applying the composition.

The heating and drying may be performed at an optional temperature, but the temperature is preferably about 50 to 400° C., and more preferably about 80 to 150° C.

The electrode may be pressed as necessary. At this time, the pressing pressure is preferably 30 kN/cm or less. As the pressing method, a generally employed method can be used, but a mold pressing method and a roll pressing method are particularly preferable. The pressing pressure is not particularly limited, but is preferably 10 kN/cm or less, and more preferably 5 kN/cm or less.

The energy storage device according to the present invention includes the above-described electrode for energy storage devices, and more specifically, includes at least one pair of positive and negative electrodes, a separator interposed between the electrodes, and an electrolyte, and at least one of the positive or negative electrode includes the above-described electrode for energy storage devices.

This energy storage device is characterized by using the above-described electrode for energy storage devices as an electrode, so that other device constituent members such as the separator and the electrolyte can be appropriately selected for use from known materials.

Examples of the separator include cellulose-based separators and polyolefin-based separators.

The electrolyte may be liquid or solid, and may be aqueous or non-aqueous. The electrode for energy storage devices of the present invention can exhibit an excellent migration suppression effect in the case of being applied to a battery with a solid electrolyte, particularly an all-solid-state battery (for example, an all-solid-state lithium ion battery).

Examples of the electrolyte salt include lithium salts such as LiPF₆, LiBF₄, LIN(SO₂F)₂, LIN(C₂F₅SO₂)₂, LiAsF₆, LiSbF₆, LiAlF₄, LiGaF₄, LiInF₄, LiClO₄, LIN(CF₃SO₂)₂, LiCF₃SO₃, LiSiF₆, LIN(CF₃SO₂), and (C₄F₉SO₂), metal iodides such as LiI, NaI, KI, CsI, and CaI₂, iodide salts of quaternary imidazolium compounds, iodide salts and perchloric salts of tetraalkylammonium compounds, and metal bromides such as LiBr, NaBr, KBr, CsBr, and CaBr₂. These electrolyte salts may be used singly or in combination of two or more kinds thereof.

The solvent is not particularly limited as long as deterioration of the battery performance is not caused by corrosion or decomposition of the substance included in the battery and the electrolyte salt is dissolved. Examples of the non-aqueous solvent to be used include cyclic esters such as ethylene carbonate, propylene carbonate, butylene carbonate, and γ-butyrolactone, ethers such as tetrahydrofuran and dimethoxyethane, chain esters such as methyl acetate, dimethyl carbonate, diethyl carbonate, and ethyl methyl carbonate, and nitriles such as acetonitrile. These solvents may be used singly or in combination of two or more kinds thereof.

As the solid electrolyte, inorganic solid electrolytes such as sulfide-based solid electrolytes and oxide-based solid electrolytes, and organic solid electrolytes such as polymer-based electrolytes can be suitably used. These solid electrolytes can be used to obtain an all-solid-state battery without using an electrolyte solution. The electrode for energy storage devices of the present invention can exhibit an excellent migration suppression effect in the case of using an inorganic solid electrolyte, particularly a sulfide-based solid electrolyte.

Examples of the sulfide-based solid electrolyte include thio-LISICON-based materials such as a Li₂S—SiS₂-lithium compound (here, the lithium compound is at least one selected from the group consisting of Li₃PO₄, LiI, and Li₄SiO₄), Li₂S—P₂S₅, Li₂S—P₂O₅, Li₂S—B₂S₅, and Li₂S—P₂S₅—GeS₂.

Examples of the oxide-based solid electrolytes include LisLa₃M₂O₁₂ (M=Nb, Ta) and Li₇La₃Zr₂O₁₂ that are an oxide having a garnet-type structure, oxyacid salt compounds basically having a γ-Li₃PO₄ structure collectively referred to as LISICON, Li_{3.3}PO_{3.8}N_{0.22} collectively referred to as perovskite-type or LIPON, and sodium/alumina. Examples of the polymer-based solid electrolyte include polyethylene oxide-based materials and polymer compounds obtained by polymerizing or copolymerizing monomers such as hexafluoropropylene, tetrafluoroethylene, trifluoroethylene, ethylene, propylene, acrylonitrile, vinylidene chloride, acrylic acid, methacrylic acid, methyl acrylate, ethyl acrylate, methyl methacrylate, styrene, and vinylidene fluoride. The polymer-based solid electrolyte may contain a supporting salt and a plasticizer.

Examples of the supporting salt contained in the polymer-based solid electrolyte include lithium (fluorosulfonylimide), and examples of the plasticizer include succinonitrile.

### EXAMPLES

Hereinafter, the present invention is more specifically described with reference to Examples and Comparative Examples, but the present invention is not limited to the following Examples. The devices used are as follows.

### (1) Probe-Type Ultrasonicator

UIP 1000 manufactured by Hielscher Ultrasonics GmbH

### (2) Wire Bar Coater (Formation of Undercoat Layer)

PM-9050MC manufactured by SMT Co., Ltd.

### (3) X-Ray Photoelectron Spectrometer (XPS)

PHI 5000 VersaProbe II manufactured by ULVAC-PHI, INC.
X-ray source: Al Kα 1486.6 eV (25 W, 15 kV)
Analyzer: Photoelectron
Take off angle: 45 deg from sample plane K

### (4) Particle Size Distribution Meter

Laser diffraction/scattering particle size distribution analyzer LA-960 manufactured by HORIBA, Ltd.

### <Measurement Conditions>

Measurement cell: flow cell
Refractive index of measurement solvent:
   1.333-0.000 i (ion-exchanged water)
Refractive index of solute: 1.920-0.522 i (carbon)
Irradiation with ultrasonic wave: none

### (5) Thermostatic Bath

DDRV422C VACUUM DRYING OVEN manufactured by ADVANTEC

### (6) Size Exclusion Chromatography (SEC)

High performance liquid chromatograph Prominence manufactured by SHIMADZU CORPORATION
Eluent: 5 mM sodium tetraborate decahydrate (pH 9.3)
Column: TSK gel a6000 manufactured by Tosoh Corporation+
   TSK gel a4000 manufactured by Tosoh Corporation
Column temperature: 40° C.
Detector: UV (210 nm)
Flow rate: 0.5 mL/min
Sample concentration: 0.1% (10 μL injection)

The raw materials and the like used are as follows.
CNT: “FloTube 6121” manufactured by iangsu Cnano Technology Co., Ltd., multi-walled CNT
WS-300: aqueous solution containing oxazoline polymer, manufactured by NIPPON SHOKUBAI CO., LTD., solid content concentration: 10.0 wt %
BTA: benzotriazole manufactured by Tokyo Chemical Industry Co., Ltd.
CBTA-1: benzotriazole-5-carboxylic acid (CAS RN: 23814-12-2), manufactured by Sigma-Aldrich (manufactured by Merck KGaA)
CBTA-2: carboxy benzotriazole (CAS RN: 60932-58-3) manufactured by Johoku Chemical Co., Ltd.
CBI: 5-carboxybenzimidazole (CAS RN: 15788-16-6) manufactured by Tokyo Chemical Industry Co., Ltd.
Ammonia water: ammonia water (28%) manufactured by JUNSEI CHEMICAL CO., LTD., guaranteed reagent
2-Propanol: manufactured by JUNSEI CHEMICAL CO., LTD., guaranteed reagent
Methacrylic acid: manufactured by JUNSEI CHEMICAL CO., LTD.
Dimethylaminoethyl methacrylate:
   manufactured by Tokyo Chemical Industry Co., Ltd.
VE-073: Azo-based polymerization initiator manufactured by FUJIFILM Wako Pure Chemical Corporation
Ethanol: manufactured by JUNSEI CHEMICAL CO., LTD.
Hexane: manufactured by JUNSEI CHEMICAL CO., LTD.

### [1] Preparation of Conductive Carbon Material Dispersion

### Preparation Example 1-1

A mixture was prepared of 0.5 g (100 parts by weight) of FloTube 6121 as a conductive carbon material, 5.0 g (100 parts by weight) of WS-300 as an aqueous solution containing an oxazoline polymer, 37.15 g of pure water, and 7.35 g of 2-propanol. The obtained mixture was subjected to ultrasonic treatment for 30 minutes using a probe-type ultrasonicator to prepare a dispersion A (solid content concentration: 2 wt %) in which the conductive carbon material was uniformly dispersed.

### [2] Preparation of Thin Film Forming Composition

### Preparation Example 2-1

To 4.0 g of water, 0.5 g of ammonia water and 0.5 g of CBTA-1 were added to prepare a 10 wt % aqueous solution of CBTA-1.

### Preparation Example 2-2

To 4.0 g of water, 0.5 g of ammonia water and 0.5 g of CBTA-2 were added to prepare a 10 wt % aqueous solution of CBTA-2.

### Preparation Example 2-3

To 4.5 g of water, 0.5 g of BTA was added to prepare a 10 wt % aqueous solution of BTA.

### Preparation Example 2-4

To 4.0 g of water, 0.5 g of ammonia water and 0.5 g of CBI were added to prepare a 10 wt % aqueous solution of CBI.

### Example 1-1

A mixture was prepared of 20 g of the dispersion A and 0.2 g of the 10 wt % aqueous solution of CBTA-1, and thus a thin film forming composition A having a solid content concentration of 2 wt % was prepared. At this time, the solvents were finally mixed at a mixing ratio of pure water:2-propanol=85:15 (weight ratio). The thin film forming composition A was a black ink in which the CNT was uniformly dispersed.

### Example 1-2

A mixture was prepared of 20 g of the dispersion A and 2 g of the 10 wt % aqueous solution of CBTA-1, and thus a thin film forming composition B having a solid content concentration of 2 wt % was prepared. At this time, the solvents were finally mixed at a mixing ratio of pure water:2-propanol=85:15 (weight ratio). The thin film forming composition B was a black ink in which the CNT was uniformly dispersed.

### Example 1-3

A mixture was prepared of 20 g of the dispersion A and 0.02 g of the 10 wt % aqueous solution of CBTA-1, and thus a thin film forming composition C having a solid content concentration of 2 wt % was prepared. At this time, the solvents were finally mixed at a mixing ratio of pure water:2-propanol=85:15 (weight ratio). The thin film forming composition C was a black ink in which the CNT was uniformly dispersed.

### Example 1-4

A mixture was prepared of 20 g of the dispersion A and 0.002 g of the 10 wt % aqueous solution of CBTA-1, and thus a thin film forming composition D having a solid content concentration of 2 wt % was prepared. At this time, the solvents were finally mixed at a mixing ratio of pure water:2-propanol=85:15 (weight ratio). The thin film forming composition D was a black ink in which the CNT was uniformly dispersed.

### Example 1-5

A mixture was prepared of 20 g of the dispersion A and 1 g of the 10 wt % aqueous solution of CBTA-2, and thus a thin film forming composition E having a solid content concentration of 2 wt % was prepared. At this time, the solvents were finally mixed at a mixing ratio of pure water:2-propanol=85:15 (weight ratio). The thin film forming composition E was a black ink in which the CNT was uniformly dispersed.

### Example 1-6

A mixture was prepared of 20 g of the dispersion A and 0.2 g of the 10 wt % aqueous solution of CBTA-2, and thus a thin film forming composition F having a solid content concentration of 2 wt % was prepared. At this time, the solvents were finally mixed at a mixing ratio of pure water:2-propanol=85:15 (weight ratio). The thin film forming composition F was a black ink in which the CNT was uniformly dispersed.

### Example 1-7

A mixture was prepared of 20 g of the dispersion A and 0.02 g of the 10 wt % aqueous solution of CBTA-2, and thus a thin film forming composition G having a solid content concentration of 2 wt % was prepared. At this time, the solvents were finally mixed at a mixing ratio of pure water:2-propanol=85:15 (weight ratio). The thin film forming composition G was a black ink in which the CNT was uniformly dispersed.

### Example 1-8

A mixture was prepared of 20 g of the dispersion A and 2 g of the 10 wt % aqueous solution of BTA, and thus a thin film forming composition H having a solid content concentration of 2 wt % was prepared. At this time, the solvents were finally mixed at a mixing ratio of pure water:2-propanol=85:15 (weight ratio). The thin film forming composition H was a black ink in which the CNT was uniformly dispersed.

### Example 1-9

A mixture was prepared of 20 g of the dispersion A and 0.2 g of the 10 wt % aqueous solution of BTA, and thus a thin film forming composition I having a solid content concentration of 2 wt % was prepared. At this time, the solvents were finally mixed at a mixing ratio of pure water:2-propanol=85:15 (weight ratio). The thin film forming composition I was a black ink in which the CNT was uniformly dispersed.

### Example 1-10

A mixture was prepared of 20 g of the dispersion A and 0.2 g of the 10 wt % aqueous solution of CBI, and thus a thin film forming composition J having a solid content concentration of 2 wt % was prepared. At this time, the solvents were finally mixed at a mixing ratio of pure water:2-propanol=85:15 (weight ratio). The thin film forming composition F was a black ink in which the CNT was uniformly dispersed.

### Comparative Example 1-1

The dispersion A was used as it was as a thin film forming composition a.

Table 1 summarizes the compositions of the thin film forming compositions A to J and a.

TABLE 1

| | | | | | | | | | | | | | Comp. |
|---|---|---|---|---|---|---|---|---|---|---|---|---|---|
| | | | Example | | | | | | | | | | Ex. |
| | | | 1-1 | 1-2 | 1-3 | 1-4 | 1-5 | 1-6 | 1-7 | 1-8 | 1-9 | 1-10 | 1-1 |
| Composition | | | A | B | C | D | E | F | G | H | I | J | a |
| Composition | Conductive | CNT | 100 | 100 | 100 | 100 | 100 | 100 | 100 | 100 | 100 | 100 | 100 |
| (pbw) | carbon material | | | | | | | | | | | | |
| | Dispersant | WS-300 | 100 | 100 | 100 | 100 | 100 | 100 | 100 | 100 | 100 | 100 | 100 |
| | Nitrogen- | CBTA-1 | 10 | 100 | 1 | 0.1 | — | — | — | — | — | — | — |
| | containing | CBTA-2 | — | — | — | — | 50 | 10 | 1 | — | — | — | — |
| | heterocyclic | BTA | — | — | — | — | — | — | — | 100 | 10 | — | — |
| | compound | CBI | | | | | | | | | | 10 | |
| | Another | Compound | — | — | — | — | — | — | — | — | — | — | — |
| | crosslinking | A | | | | | | | | | | | |
| | agent | | | | | | | | | | | | |

| | | | | | | | | | | | |
|---|---|---|---|---|---|---|---|---|---|---|---|
| Solid content concentration (wt %) | 2 | 2 | 2 | 2 | 2 | 2 | 2 | 2 | 2 | 2 | 2 |

### [3] Evaluation of Dispersion Stability

The particle size distribution (median diameter d50 and d90) of each of the obtained thin film forming compositions A, C, D, F, and a was measured using a particle size distribution meter immediately after the preparation (before storage) and after the storage for 1 day under heating conditions. Table 2 shows the results.

To heat the dispersion, the dispersion was put into a 20 ml sample tube, and the sample tube was allowed to stand in a thermostatic bath heated to 45° C. for 1 day. Thereafter, the dispersion was taken out from the thermostatic bath, cooled to room temperature, and then used for measurement of the particle size distribution. In the present invention, the term “room temperature” means 23° C.±5° C., and the room temperature is preferably 23° C.

TABLE 2

| | | Nitrogen- | Amount of | | | | |
|---|---|---|---|---|---|---|---|
| | | containing | composition | | | | |
| | | heterocyclic | added | Before storage | | After storage | |
| | Composition | compound | (pbw) | d₅₀ (μm) | d₉₀ (μm) | d₅₀ (μm) | d₉₀ (μm) |
| Example 1-1 | A | CBTA-1 | 10 | 0.79 | 1.58 | 0.89 | 1.92 |
| Example 1-3 | C | CBTA-1 | 1 | 0.91 | 1.99 | 0.97 | 1.92 |
| Example 1-4 | D | CBTA-1 | 0.1 | 0.96 | 1.91 | 0.81 | 1.60 |
| Example 1-6 | F | CBTA-2 | 10 | 0.89 | 1.96 | 0.92 | 1.83 |
| Comparative | a | — | — | 0.73 | 1.48 | 11.20 | 18.76 |
| Example 1-1 | | | | | | | |

In Examples 1-1, 1-3, 1-4, and 1-6, it was confirmed that the particle size of the CNT was small before storage and good dispersibility was ensured. After the storage, the particle size of the CNT was almost not different from the particle size before the storage, and thus it was confirmed that the dispersion state of the CNT was not changed and a good dispersion state was maintained.

In Comparative Example 1-1, the particle size of the CNT was small before storage, and good dispersibility was obtained. However, it was confirmed that after the storage, the particle size of the CNT was increased and the CNT was aggregated. From these results, it was confirmed that the dispersion state of the CNT was more likely to change in the dispersion of Comparative Example 1-1 than in the dispersions of Examples, and that the dispersion of Comparative Example 1-1 was inferior in the effect of suppressing aggregation to the dispersions in Examples.

### [4] Production of Composite Current Collector

### Example 2-1

The thin film forming composition A was uniformly spread on a copper foil (thickness: 15 μm) as a current collector using a wire bar coater of OSP-30 and then dried at 120° C. for 20 minutes to form a thin film (undercoat layer), and thus a composite current collector was produced. The obtained composite current collector was a laminate in which the surface of the copper foil was uniformly covered with the conductive carbon material (assumed coating weight: 450 mg/m²).

Here, the term “assumed coating weight” means a coating weight assumed when a thin film forming composition having a predetermined solid content concentration is applied to a current collector using a predetermined wire bar coater. In the present invention, the assumed coating weight in the case of using a thin film forming composition having a solid content concentration of 2 wt % is as follows.
OSP-30:450 mg/m²
OSP-6:100 mg/m²

### Example 2-2

A composite current collector was produced in the same manner as in Example 2-1 except that the thin film forming composition A was uniformly spread on a copper foil (thickness: 15 μm) as a current collector using a wire bar coater of OSP-6. The obtained composite current collector was a laminate in which the surface of the copper foil was uniformly covered with the conductive carbon material (assumed coating weight: 100 mg/m²).

### Example 2-3

A composite current collector was produced in the same manner as in Example 2-2 except that the thin film forming composition B was used instead of the thin film forming composition A.

### Example 2-4

A composite current collector was produced in the same manner as in Example 2-2 except that the thin film forming composition C was used instead of the thin film forming composition A.

### Example 2-5

A composite current collector was produced in the same manner as in Example 2-2 except that the thin film forming composition D was used instead of the thin film forming composition A.

### Example 2-6

A composite current collector was produced in the same manner as in Example 2-2 except that the thin film forming composition E was used instead of the thin film forming composition A.

### Example 2-7

A composite current collector was produced in the same manner as in Example 2-1 except that the thin film forming composition F was used instead of the thin film forming composition A.

### Example 2-8

A composite current collector was produced in the same manner as in Example 2-2 except that the thin film forming composition F was used instead of the thin film forming composition A.

### Example 2-9

A composite current collector was produced in the same manner as in Example 2-2 except that the thin film forming composition G was used instead of the thin film forming composition A.

### Example 2-10

A composite current collector was produced in the same manner as in Example 2-2 except that the thin film forming composition H was used instead of the thin film forming composition A.

### Example 2-11

A composite current collector was produced in the same manner as in Example 2-2 except that the thin film forming composition I was used instead of the thin film forming composition A.

### Example 2-12

A composite current collector was produced in the same manner as in Example 2-2 except that the thin film forming composition J was used instead of the thin film forming composition A.

### Comparative Example 2-1

A composite current collector was produced in the same manner as in Example 2-2 except that the thin film forming composition a was used instead of the thin film forming composition A.

### Comparative Example 2-2

A composite current collector was produced in the same manner as in Example 2-1 except that a thin film forming composition b was used instead of the thin film forming composition A.

### Comparative Example 2-3

A composite current collector was produced in the same manner as in Example 2-2 except that the thin film forming composition b was used instead of the thin film forming composition A.

### [5] Evaluation of Copper Migration Suppression Effect

For the composite current collectors of Examples 2-1 to 2-12 and Comparative Examples 2-1 to 2-3, the amount of Cu present on the surface of the thin film was measured using an XPS immediately after the production (before storage) and after the storage for 1 day under heating conditions with the following method. With the XPS, each of C, O, N, and Cu was measured three times, and an average value of the obtained measurement values was calculated. Table 3 shows the results.

### <<Storage Method>>

The composite current collector was processed into 20 mm×40 mm and put into a 20 mL sample tube, and the sample tube was allowed to stand without a lid in a thermostatic bath heated to 80° C. for 1 day in order to facilitate copper migration. Thereafter, the sample tube was taken out from the thermostatic bath, cooled to room temperature, and then used for measurement with an XPS. In the present invention, the term “room temperature” means 23° C.±5° C., and the room temperature is preferably 23° C.

TABLE 3

| | | | | Measurement with XPS | |
|---|---|---|---|---|---|
| | | | Assumed | Before | After |
| | | | coating | storage | storage |
| | Compo- | Wire | weight | Cu | Cu |
| | sition | bar | (mg/m²) | (atm %) | (atm %) |
| Example 2-1 | A | 30 | 450 | 0.1 | 0.1 |
| Example 2-2 | A | 6 | 100 | 0.1 | 0.3 |
| Example 2-3 | B | 6 | 100 | 0.0 | 0.0 |
| Example 2-4 | C | 6 | 100 | 0.3 | 0.3 |
| Example 2-5 | D | 6 | 100 | 0.3 | 0.3 |
| Example 2-6 | E | 6 | 100 | 0.3 | 0.3 |
| Example 2-7 | F | 30 | 450 | 0.3 | 0.3 |
| Example 2-8 | F | 6 | 100 | 0.2 | 0.2 |
| Example 2-9 | G | 6 | 100 | 0.3 | 0.3 |
| Example 2-10 | H | 6 | 100 | 0.3 | 0.3 |
| Example 2-11 | I | 6 | 100 | 0.1 | 0.1 |
| Example 2-12 | J | 6 | 100 | 0.2 | 0.3 |
| Comparative | a | 6 | 100 | 0.1 | 0.4 |
| Example 2-1 | | | | | |
| Comparative | b | 30 | 450 | 0.1 | 0.5 |
| Example 2-2 | | | | | |
| Comparative | b | 6 | 100 | 0.1 | 0.7 |
| Example 2-3 | | | | | |

In the composite current collectors of Examples, it was confirmed that little Cu was detected on the surface of the thin film before storage. Even after the storage, Cu on the surface of the thin film was increased little. This result indicates that copper is not diffused to the surface of the thin film even when the composite current collector is heat-treated, that is, the thin film has an effect of suppressing copper migration.

Meanwhile, in the composite current collectors of Comparative Examples, it was confirmed that little Cu was detected on the surface of the thin film before storage, but Cu on the surface of the thin film significantly increased after the storage. That is, it was confirmed that the thin film free of a nitrogen-containing heterocyclic compound had no effect of suppressing copper migration.

### [6] Evaluation of Adhesion of Thin Film

The thin film on the composite current collector of each of Examples 2-1 to 2-8 and Comparative Example 2-1 was rubbed back and forth three times using a nonwoven fabric wiper (BEMCOT (registered trademark): trade name) containing water under a load of 100 to 120 g. Thereafter, the state of the thin film was visually observed and evaluated in accordance with the following criteria. Table 4 shows the results.

### <<Evaluation Criteria>>

◯: No stripping occurred.

x: Stripping occurred.

TABLE 4

| | | | Assumed | |
|---|---|---|---|---|
| | | Wire | coating weight | |
| | Composition | bar | (mg/m²) | Adhesion |
| Example 2-1 | A | 30 | 450 | ◯ |
| Example 2-2 | A | 6 | 100 | ◯ |
| Example 2-3 | B | 6 | 100 | ◯ |
| Example 2-4 | C | 6 | 100 | X |
| Example 2-5 | D | 6 | 100 | X |
| Example 2-6 | E | 6 | 100 | ◯ |
| Example 2-7 | F | 30 | 450 | X |
| Example 2-8 | F | 6 | 100 | X |
| Comparative | a | 6 | 100 | X |
| Example 2-1 | | | | |

In the thin films formed from the compositions A and B, stripping was not confirmed. However, in the thin films formed from the compositions C and D, stripping was confirmed. In the thin film formed from the composition E, stripping was not confirmed. However, in the thin films formed from the compositions F and G, stripping was confirmed.

This result is considered to be due to the reaction of the carboxy group included in CBTA-1 with the oxazoline group included in the dispersant during heating and drying. It is considered that as a result of adding a certain amount or more of CBTA-1, the polymer including an oxazoline group to which CBTA-1 was bonded and copper ions were bonded to each other to develop the adhesion of the thin film. The same applies to CBTA-2.

1. A thin film forming composition for energy storage device electrodes, comprising:
a conductive carbon material;
a heterocyclic compound including two or more nitrogen atoms constituting a ring;
a dispersant; and
a solvent.

2. The thin film forming composition for energy storage device electrodes of claim 1, wherein the heterocyclic compound has the following formula (n1): 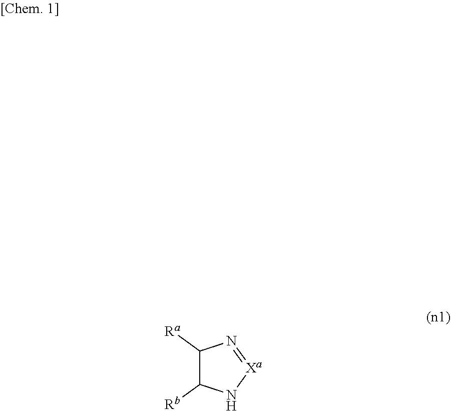
wherein R^{a} and R^{b} each independently represent a hydrogen atom, a halogen atom, an alkyl group that has 1 to 6 carbon atoms and may have a substituent, an alkenyl group that has 2 to 6 carbon atoms and may have a substituent, or an aryl group that has 6 to 12 carbon atoms and may have a substituent, R^{a} and R^{b} may be bonded to each other to form a ring having 4 to 6 carbon atoms, and X^{a} is N or CH.

3. The thin film forming composition for energy storage device electrodes of claim 2, wherein each substituent is at least one selected from the group consisting of a carboxy group, a hydroxy group, a thiol group, an amino group, a sulfonate group, and an epoxy group.

4. The thin film forming composition for energy storage device electrodes of claim 2, wherein the heterocyclic compound has the following formula (n2): 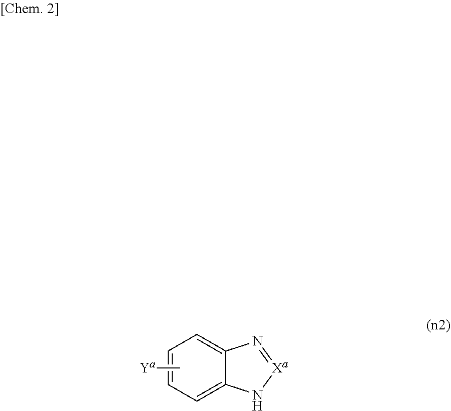
wherein Y^{a} represents a hydrogen atom, a carboxy group, a hydroxy group, a thiol group, an amino group, a sulfonate group, or an epoxy group, and X^{a} is as described above.

5. The thin film forming composition for energy storage device electrodes of claim 4, wherein the heterocyclic compound has the following formula (n3):

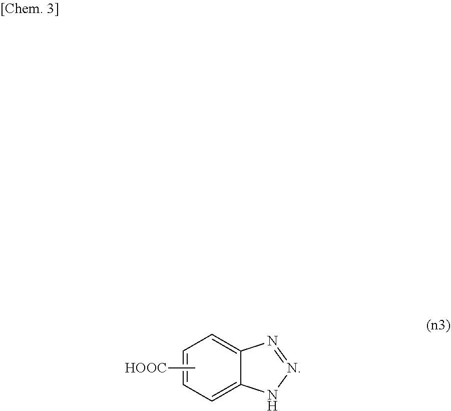

6. The thin film forming composition for energy storage device electrodes of claim 1, wherein the dispersant includes a pendant oxazoline group-containing polymer.

7. The thin film forming composition for energy storage device electrodes of claim 1, wherein the solvent includes one or more selected from the group consisting of water and hydrophilic solvents.

8. The thin film forming composition for energy storage device electrodes of claim 1, further comprising a crosslinking agent.

9. An undercoat layer comprising a thin film obtained from the thin film forming composition for energy storage device electrodes of claim 1.

10. A composite current collector for energy storage device electrodes, comprising:
a current-collecting substrate; and
the undercoat layer of claim 9 formed on the current-collecting substrate.

11. The composite current collector for energy storage device electrodes of claim 10, wherein the current-collecting substrate is a copper foil.

12. An electrode for energy storage devices, comprising the composite current collector for energy storage device electrodes of claim 10.

13. An energy storage device comprising the electrode for energy storage devices of claim 12.

14. The energy storage device of claim 13, being a lithium ion battery.

15. The energy storage device of claim 13, wherein an electrolyte is a solid.

16. The energy storage device of claim 13, being an all-solid-state battery.
